(19) United States
(12) Patent Application Publication
(10) Pub. No.: US 2001/0027375 A1
(43) Pub. Date: Oct. 4, 2001

(54) Geographic information output system

(75) Inventors: Yoshiyuki Machida, Kawasaki (JP); Masao Hayama, Yokohama (JP); Joichi Saito, Yokohama (JP); Fumihiko Shimazaki, Yokohama (JP); Yuichiro Katsu, Fujisawa (JP)

Correspondence Address: SOFER & HAROUN, L.L.P, Suite 1921, 342 Madison Avenue, New York, NY, 10173, US

(73) Assignee: Hitachi, Ltd.

(21) Appl. No.: 09/769,916

(22) Filed: Jan. 25, 2001

(30) Foreign Application Priority Data
Mar. 29, 2000 (JP) 2000-095199

(51) Int. Cl. G01C 21/30

(52) U.S. Cl. 701/209; 340/990

(57) ABSTRACT

The present invention is intended to achieve optimum navigation services for moving means types corresponding to automobiles, bicycles, wheelchairs and walking. Moving means type information about a moving means type to be used by a user who desires the supply of route information is produced, and a starting position data on a starting position from which the user starts is obtained. A map of an area surrounding the starting position is extracted from map data for the moving means type and the same map is displayed. A destination to which the user desires to travel is specified, map data for the moving means type is searched for a route by using the starting position and the destination as keys for retrieval, and an optimum route for the moving means type is extracted.

### BACKGROUND OF THE INVENTION

The present invention relates to a navigation system that provides users with map data and road guidance.

Current car navigation devices use a CD-ROM or a DVD-ROM as a map data storage medium.

Other known navigation devices use a VICS (vehicle information and communication system) to find a route to avoid being involved in traffic congestion on the basis of traffic information about traffic congestion acquired from information broadcast by FM multiplex broadcasting or signals emitted by light or radio beacons.

Portable navigation devices for walkers are marketed.

Navigation devices related with the present invention includes those for vehicles or walkers. Actually, there are many mobile objects of widely different mobile characteristics other than vehicles and walkers.

### SUMMARY OF THE INVENTION

It is a principal object of the present invention to provide a geographic information output system capable of providing different mobile objects with navigation data meeting the different characteristics of the mobile objects.

According to the present invention, a mobile station identifies a moving means type, i.e., the type of a moving means used by a user, determines the current position of the user, and sends signals indicating the moving means type, the current position, a destination and the like to a server. The server holds road databases respectively for moving means types, determines a route on the basis of the data on the moving means type, the current position and the destination provided by the mobile station, and sends guidance data on the determined route to the mobile station. Upon the reception of the guidance data, the mobile station displays the guidance data on a display or announces the guide data to inform the user of the guidance data.

### BRIEF DESCRIPTION OF THE DRAWINGS

Preferred embodiments of the present invention will now be described in conjunction with the accompanying drawings, in which:

FIG. 1 is a block diagram of a geographic information output system in a preferred embodiment according to the present invention;

FIG. 2 is a view showing the construction of a geographic database;

FIG. 3 is a flow chart of a moving means type setting procedure for setting the moving means type of a moving means to be used by a mobile station;

FIG. 4 is a sequence diagram showing a signal sequence for displaying a map image including a current position on a mobile station;

FIG. 5 is a sequence diagram showing a signal sequence for providing a navigation guidance service;

FIG. 6 is a view showing a route data retrieval request message by way of example;

FIG. 7 is a view showing a route data transfer format;

FIG. 8 is view showing the construction of map data;

FIG. 9 is a view showing geographical information about a node;

FIG. 10 is a view showing attribute information about a link;

FIG. 11 is a table of speed coefficients for different moving means types;

FIG. 12 is a flow chart of a route finding procedure;

FIG. 13 is a diagrammatic view showing an area around a guided person;

FIG. 14 is a diagrammatic view showing the result of a route finding operation for an automobile;

FIG. 15 is a diagrammatic view showing the result of a route finding operation for bicycles;

FIG. 16 is a diagrammatic view showing the result of a route finding operation for wheelchairs;

FIG. 17 is a diagrammatic view showing the result of a route finding operation for a walker;

FIG. 18 is a block diagram of a cradle; and

FIG. 19 is a sequence diagram showing a map updating signal sequence.

### DESCRIPTION OF THE PREFERRED EMBODIMENTS

A preferred embodiment of the present invention will be described hereinafter. The embodiment described herein is only an example and the technical scope of the present invention is not limited by the embodiment specifically described herein.

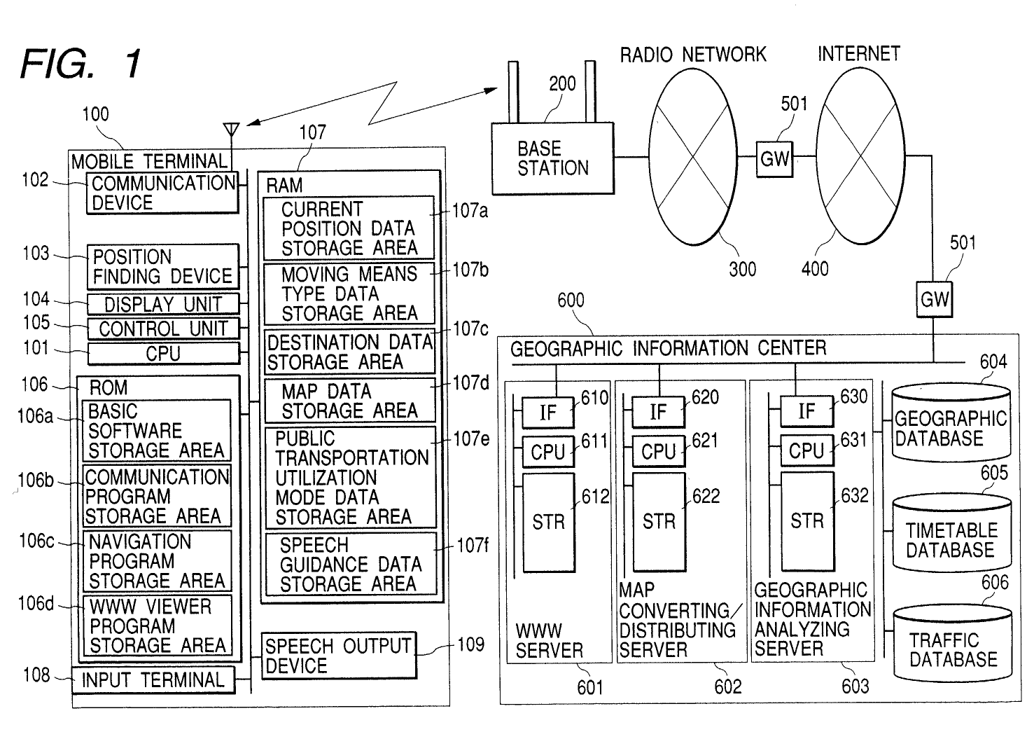

FIG. 1 shows a geographic information output system in a preferred embodiment according to the present invention. In this embodiment, a server on a network or a mobile station is provided with a geographic database associated with a moving means type to provide the user with navigation guidance service associated with the user's moving means type. Geographic information signifies information including maps, routes from starting positions to destinations, time necessary for movement, and traffic guidance information, such as navigation information. Moving means type data represents moving means to be used by users for movement, such as automobiles (motorcycles and four-wheeled vehicles), bicycles, trains, wheelchairs, feet, ships and aircraft; that is, the moving means type data is the general designation of information useful not only for moving users but also for users who will intend to move in the future to plan a movement. The term “user” signifies not only an object actually traveling a route but also a person who enjoys advantages of the present invention and a person who operates the geographic information output system of the present invention.

A mobile station 100 comprises a CPU 101 for controlling the terminal, a communication device 102 that communicates through radio channels with a base station 200, a position finding device 103 that finds the current position of the mobile station 100, a display unit 104 that displays map data, operation menus and such, a control unit 105 having letter keys, numeric keys, cursor control keys and the like, a ROM 106 having a basic software storage area 106a, a communication program storage area 106b, a navigation program storage area 106c and a WWW viewer program storage area 106d, and a RAM 107 including a current position data storage area 107a holding current position data on the current position of the mobile station 100, a moving means type data storage area 107b for storing moving means type data on the moving means type of the mobile station, a destination data storage area 107c for storing destination data on a destination, a map data storage area 107d for storing map data, and a public transportation utilization mode data storage area 107e for storing public transportation utilization mode data. The ROM 106 and the RAM 107 may be any kinds of storage devices, such as flash memories capable of being incorporated into mobile stations. The destination is a place to which the user wants to move, and points on a route other than a starting point, such as a terminal point and middle points.

The base station is connected to a radio network 300. A radio system including the mobile station 100, the base station 200 and the radio network is a public radio communications system for portable telephones. Desirably, although the navigation system of the present invention uses radio packet communications because the navigation system sends out and receives data periodically, the navigation system may be of any type of radio communications system.

The radio network 300 is connected through a gateway 501 to the Internet. The gateway is a means of connecting different systems. The mobile station 100 connected to the base station 200 is able to communicate with the Internet 400 through the radio network 300 and the gateway 501. Thus, the mobile station 100 is able to gain access to an optional sever on the Internet 400. Part of the system in this embodiment may be replaced with a system disclosed in Japanese Patent Laid-open No. Hei 9-166450.

The position finding device 103 finds the current position of the mobile station 100 and provides a signal representing the current position. More concretely, the position finding device 103 finds the current position by a method that uses the GPS (Global Positioning System), a method that receives information sent out periodically by the base station 200 and determines the current position of the mobile station 100 on the basis of position information included in the information provided by the base station 200 or, when the radio system uses a spread spectrum communication system in which a plurality of base stations send out signals spread by PN codes of the same series, a method that makes the mobile station determine the current position through the calculation of the difference between propagation delays of signals sent out by the plurality of base stations.

The mobile station 100 is a terminal device of a PDA type (personal digital assistant type) integrally comprising the CPU 101, the communication device 102, the position finding device 103, the display unit 104, the control unit 105, the ROM 106 and the RAM 107 or a terminal device of a notebook-sized personal computer type including, in combination, an adapter having the functions of the communication device 102 and the position finding device 103, and a notebook-type personal computer having the functions of the rest of the components.

A navigation system related with this embodiment employs a comparatively large map information recording medium, such as a CD-ROM, and hence the system cannot be miniaturized in a size smaller than that of the CD-ROM. Therefore, the navigation system is not suitable for a walker to carry around. In this embodiment, map data is held on the network and the mobile station 100 obtains only necessary map data by downloading the same from the network.

The Internet 400 is connected through the gateway 501 to a geographic information center 600. The geographic information center 600 comprises a WWW server 601, a map converting/distributing server 602 that converts vector map data into raster map image data and transfers the raster map image data to the WWW server 601, a geographic information analyzing server 603 that carries out operations for route finding and route analysis, a geographic database 604 storing map data, a timetable database 605 storing timetable data of public transportation, such as trains and buses, and a traffic database 606 storing real-time road information about accidents, traffic congestion and construction work that will change from time to time.

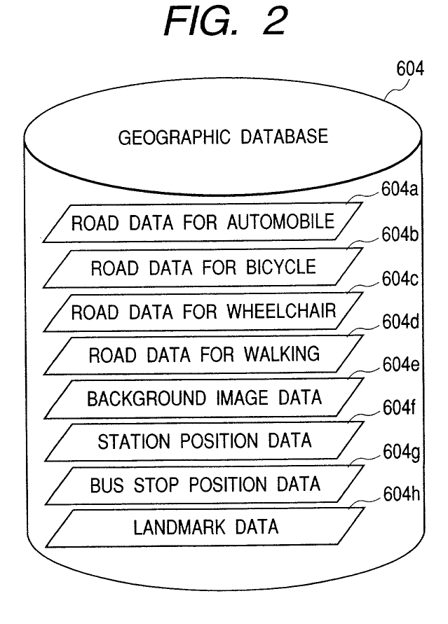

The navigation system related with this embodiment is intended for use by a vehicle or a walker. Practically, there are various moving means types of widely different movement characteristics. For example, an automotive navigation system uses maps on a greatly reduced scale. Such maps are difficult for walkers and users on wheelchairs to find the current position. This embodiment provides navigation services respectively meeting the characteristics of different moving means types. As shown in FIG. 2, the geographic database 604 has map data for moving means types, such as road data for automobile 604a, road data for bicycle 604b, road data for wheelchair 604c, road data for walking 604d, background image data 604e, station position data 604f, bus stop position data 604g landmark data 604h. The map data for each moving means type may be a collection of individual data or may be less pieces of data provided by integrating map data.

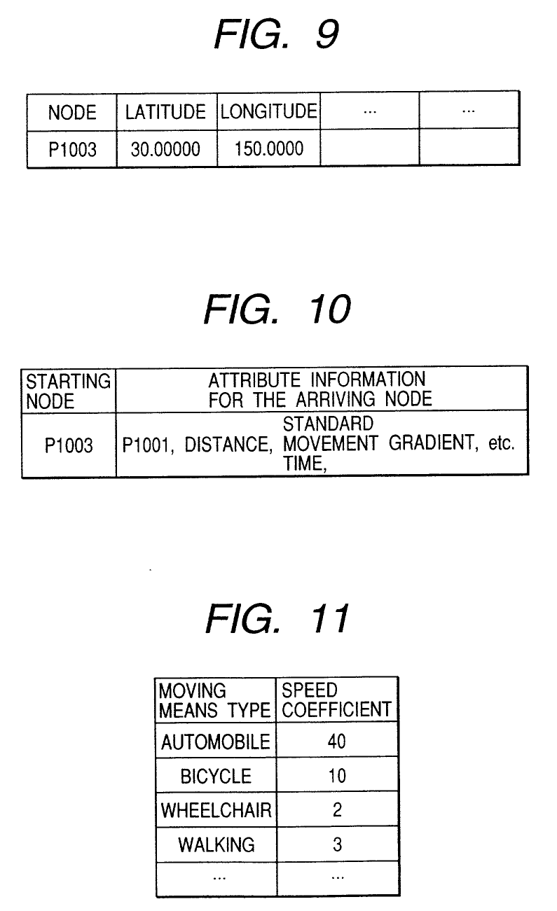

The road data 604a to 604d include information about available roads. FIG. 8 shows a concrete example of the road data. The road data is a collection of vector line patterns. One line is represented by link information about a starting node and an arriving node. As shown in FIG. 9, each node is indicated by latitude/longitude coordinate information. Each line determined by a starting node and an arriving node has attribute information.

Attribute information is stored in one record and is in one-to-one correspondence with a line pattern. As shown in FIG. 10, the attribute information includes information about the distance of the line, speed limits, gradients and standard necessary traveling time. The road data for automobile 604a has node information about only points that can be passed by automobiles, link information and the attribute information. To enable route finding taking into consideration one-way roads, link information is not attached to a node at the exit of a one-way road to provide the same node with no-traffic information.

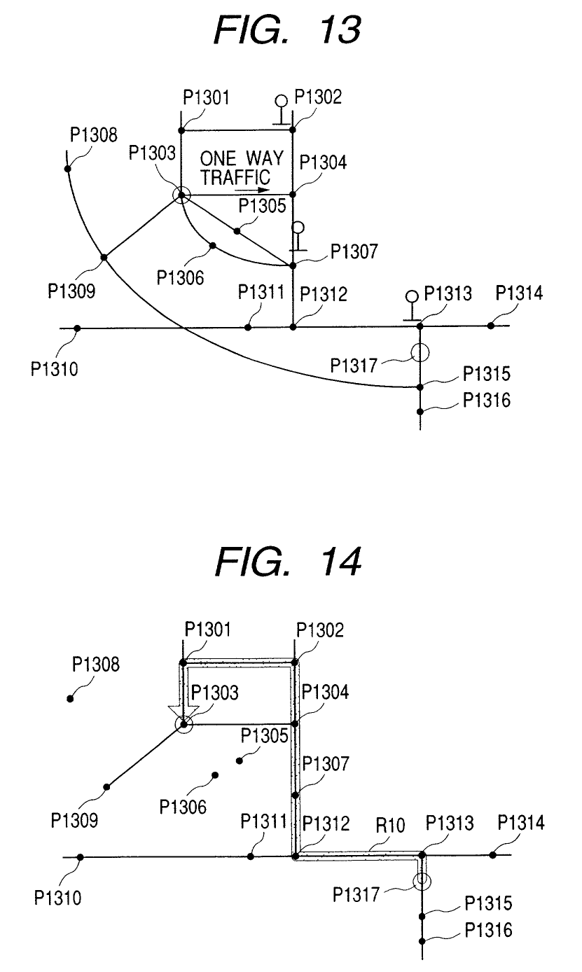

For example, as shown in FIG. 13, a line between nodes P1303 and P1304 represents a one-way road. In an automobile section of FIG. 8, a link is extended from the node P1303 to the node P1304, and any link is not extended from the node P1304 to the node P1303 to indicate that the line is a one-way road. As shown in a wheelchair section of FIG. 8, pieces of link information are attached to both the entrance (node P1303) and the exit (node P1305) of a line representing a two-way road.

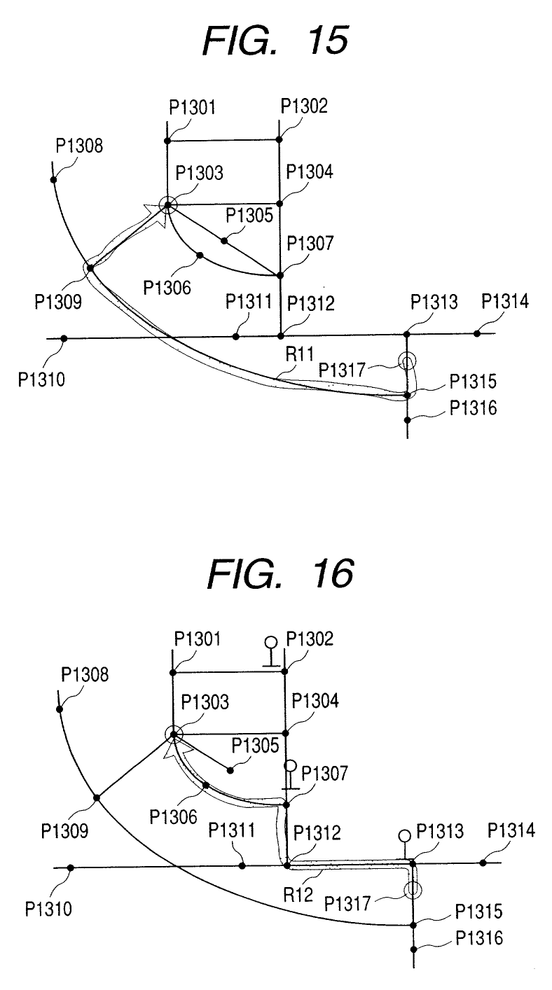

The road data for bicycle 604b has node information, link information and the attribute information for only points that can be passed by bicycles, link information and the attribute information. FIG. 15 shows roads that can be traveled by bicycles. FIG. 15 includes a cycling road (P1315-P1309-P1308) in addition to roads shown in FIG. 14. As shown in a bicycle section of FIG. 8, a link is extended from a node P1315 to a new node P1309.

It is difficult for a user on a wheelchair to travel bumpy roads and hence roads as barrier-free as possible must be selected for wheelchairs. Since the navigation system related with the present invention does not take bumps on roads into consideration, it is possible that a user on a wheelchair is unable to reach a destination along a route selected by the navigation system. Therefore, the wheelchair route data 604c has node information about only points that can be passed by wheelchairs, link information and the attribute information. FIG. 16 shows a map for wheelchairs. Route finding operation takes into consideration roads that are difficult for wheelchairs to travel. Therefore, any link information is not attached to the wheelchair route data 604c representing a bumpy road, such as a road between nodes P1305 and P1307, and steep roads which is practically impossible for wheelchairs to travel. As shown in a wheelchair section of FIG. 8, any link is extended between the nodes P1305 and P1307.

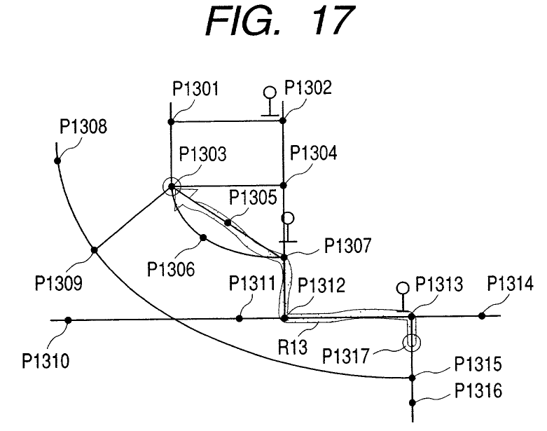

The road data for walking 604d has node information, link information and the attribute information for only points that can be passed by walkers. FIG. 17 shows a map for walkers. A link is extended between nodes P1305 and P1307 as shown in a walking section of FIG. 8 because walkers are able to walk bumpy roads. The background image data 604e is raster data including data on land utilization images, building images and place name character pictures, which are necessary for forming a map image. The station position data 604f has node information about nodes corresponding to stations and link information about links between the nodes. The bus stop position data 604g has node information about nodes corresponding to bus stops and link information about links between the nodes. The landmark data 604h has data on the names of tourist attractions and buildings, and data on the latitude and longitude of each of such tourist attractions and buildings.

The geographic information analyzing server 603 is capable of selecting route data on an optimum route for a specified moving means type, of calculating the distance of the optimum route and of calculating time necessary to travel the route on the basis of position information about a starting place and a destination, a moving means type and an average speed for the moving means type. Although the present invention uses a Dijkstra's method for route finding, any other suitable route finding method may be used.

The navigation system related with this embodiment is incapable of taking into consideration waiting time in finding an optimum route when the user uses public transportation, such as trains and buses. The geographic information analyzing server 603 finds a route using public transportation and takes waiting time into consideration when the moving means type of the user corresponds to walking or wheelchairs. In this case, first a conveyance boarding point where the user takes a public conveyance and a conveyance leaving point where the user leaves the public conveyance are retrieved from the station position data 604f and the bus stop position data 604g with reference to a given starting point and a given destination. The position data includes information about the latitude and longitude of each of the conveyance boarding point and the conveyance leaving point. Subsequently, a public conveyances available for a route between the conveyance boarding point and the conveyance leaving point is retrieved from the station position data 604f and the bus stop position data 604g. Lastly, the road data for wheelchair 604c or the road data for walking 604d are searched for roads from the starting point to the conveyance boarding point and from the conveyance leaving point to the destination to obtain route data on the roads. The distances of sections associated with moving means types of route between the starting point and the destination are determined. The distances are multiplied by the speed coefficients for the moving means types, respectively, to calculate times necessary for traveling the sections associated with the moving means types. The times are added up to calculate time necessary for traveling the route. A table of speed coefficients shown in FIG. 11 may be included in the geographic database 604. Thus, part of the geographic database 604 storing the speed coefficients may be called a speed coefficient storage device.

Another calculating method sums up standard moving times for the sections shown in FIG. 10. For example, data representing standard moving times necessary for moving means types to move each section is stored as additional information in addition to the map data as shown in FIG. 10, the standard time necessary for a moving means type identified by the controller to move the section is read from the map data, and a standard moving time necessary for traveling the route can be determined by adding up the standard necessary times for all the sections thus determined. The standard moving time thus calculated is displayed by the display unit.

The map converting/distributing server 602 superposes the calculated route data and the background image data 604e to produce a map image data on an optional reduced scale. The geographic database 604, the timetable database 605 and the traffic database 606 are connected to the geographic information analyzing server 603. The WWW server 601, the map converting/distributing server 602 and the geographic information analyzing server 603 are connected on a LAN included in the geographic information center 600 for mutual communication.

The system needs to identify the moving means type to enable carrying out navigation according to the moving means type. The identification of the moving means type is the determination of the type of movement of the user. For example, the moving means type is specified by an operation based on the user's intention, by operating a selector switch or by an operation in cooperation with an external device, such as a cradle. The identification of the moving means type does not need to be made on the level of human recognition and may be made on a level which can be dealt with by the system.

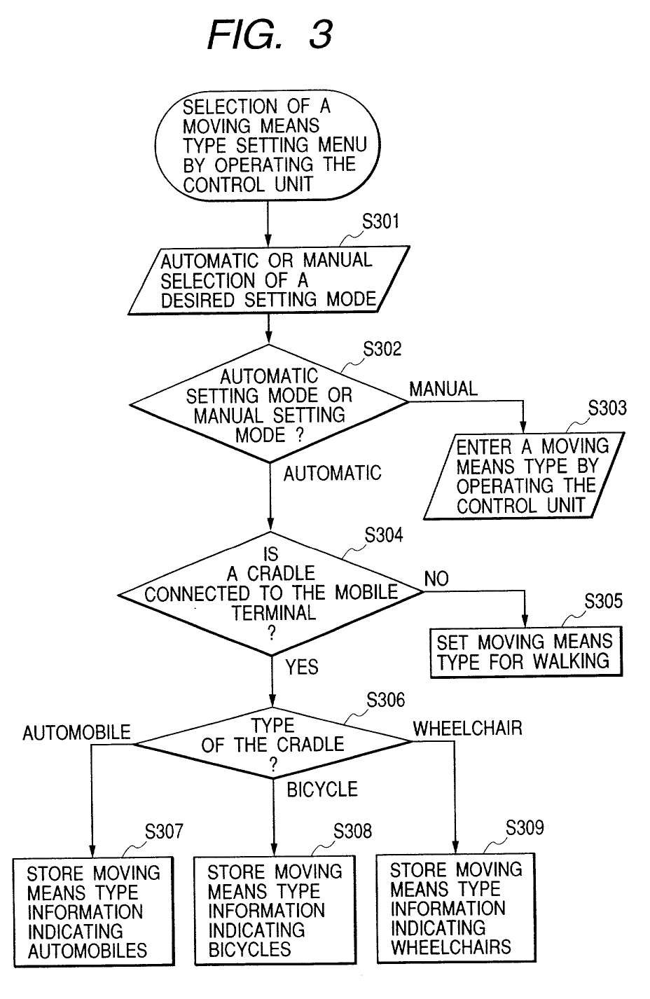

A procedure for setting a moving means type for the mobile station 100 included in the system shown in FIG. 1 will be described with reference to FIG. 3. A person who uses the mobile station 100 to receive navigation service is called a user. A menu selection dialog box including a moving means type setting menu is displayed by the display unit 104. The user operates the control unit 105 to enter an instruction. The control unit 105 transfers the instruction to the CPU 101. When the CPU 101 decides that the instruction received from the control unit 105 signifies the selection of a moving means type setting menu, the CPU 101 makes the display unit 104 display a moving means type setting mode selection dialog box for selecting either an automatic setting mode or a manual setting mode. The display unit 104 displays the moving means type setting mode selection dialog box and prompts the user to select a desired setting mode (S301). Then, the CPU 101 examines the setting mode selected by operating the control unit 105 (S302). If a manual setting mode is selected, the CPU 101 makes the display unit 104 display moving means types representing automobiles, bicycles, wheelchairs and walking. The user selects one of the moving means types and operates the control unit 105 to specify the selected moving means type. Then, the CPU 101 decides whether or not any moving means type is specified by operating the control unit 105, stores information about the selected moving means type in the moving means type data storage area 107b in the RAM 107 to complete the moving means type setting operation (S303).

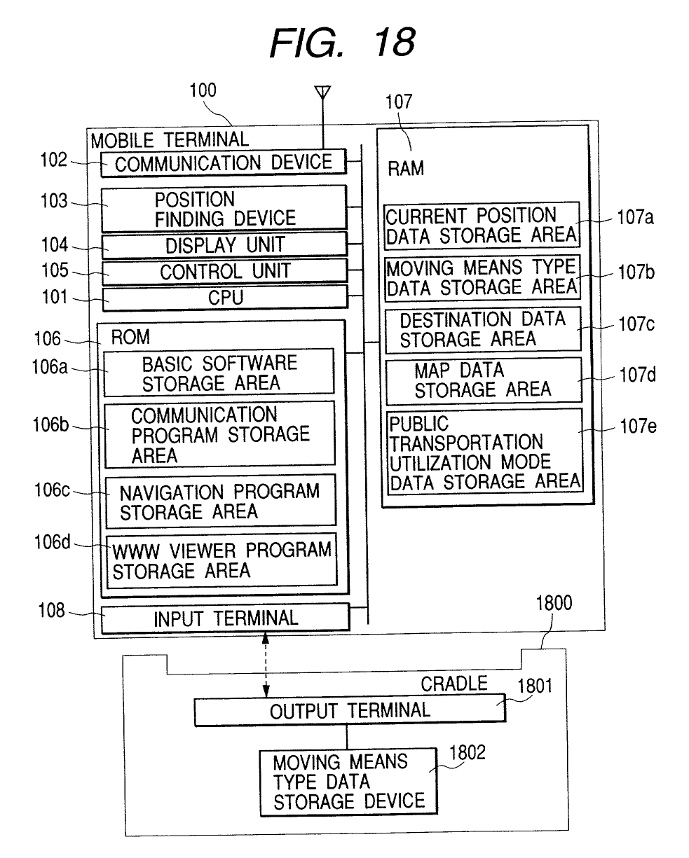

If an instruction specifying an automatic setting mode is entered, the CPU 101 makes a query to see if a cradle is connected to the mobile station 100 (S304). A cradle is a device to support or hold the mobile station 100. FIG. 18 shows a cradle. A cradle 1800 has an output terminal 1801 and a moving means type storage device 1802. Cradles are designed for automobiles, bicycles, wheelchairs and the like, respectively. The moving means type storage devices 1802 of cradles for automobiles, bicycles and wheelchairs store different values, respectively. When the output terminal 1801 is connected to the mobile station 100, values stored in the moving means type storage device 1802 is read and a signal representing a moving means type is given to the mobile station 100. The mobile station 100 receives the signal specifying a moving means type through an input terminal 108. When the mobile station 100 is connected to the cradle, the CPU 101 analyzes an identification signal received at the input terminal 108 to determine the type of the cradle (S306). If it is found that the cradle is for automobiles, the CPU 101 stores moving means type information (moving means type data) indicating automobiles in the moving means type data storage area 107b to complete the moving means type setting operation (S307). If it is found that the cradle is for bicycles, the CPU 101 stores moving means type information indicating bicycles in the moving means type data storage area 107b to complete the moving means type setting operation (S308). If it is found that the cradle is for wheelchairs, the CPU 101 stores moving means type information indicating wheelchairs in the moving means type data storage area 107b to complete the moving means type setting operation (S309).

If any cradle is not connected to the mobile station 100 and any identification signal is not applied to the input terminal 108, the CPU 101 decides that the moving means type is walking and stores moving means type information indicating walking in the moving means type data storage area 107b to complete the moving means type setting operation (S305).

A moving means identifying device disclosed in Japanese Patent Laid-open No. Hei 10-232992 may be used instead of the foregoing system.

Current Position Displaying Procedure

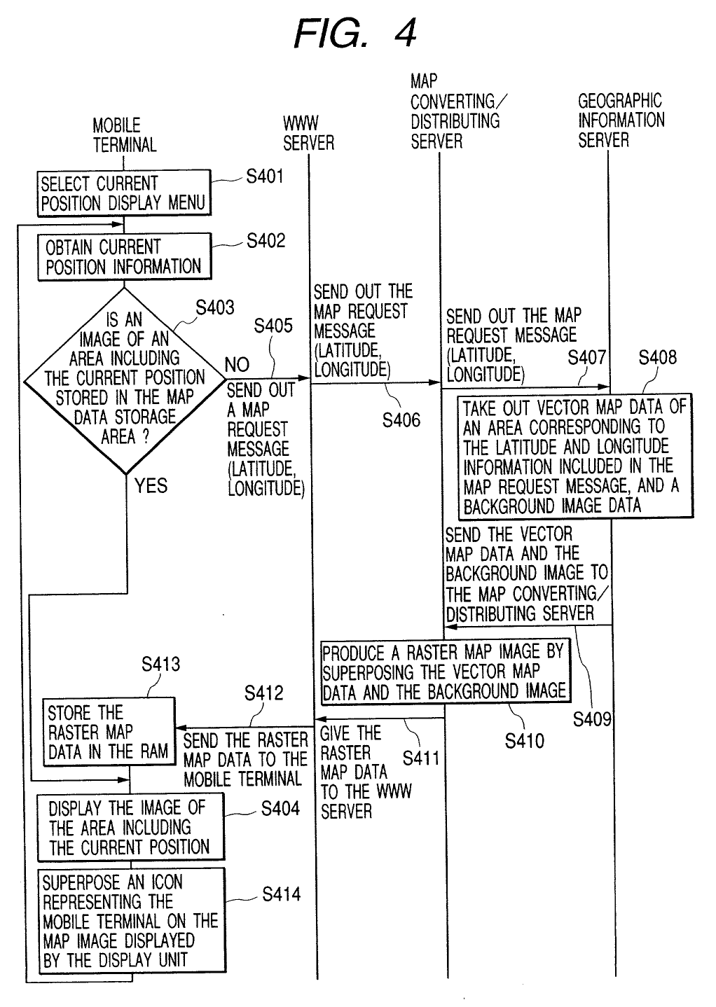

A current position displaying procedure for displaying the current position of the mobile station 100 will be described with reference to FIG. 4. First the display unit 104 displays a menu selection dialog box including a current position display menu. The user operates the control unit 105 to give an instruction to the CPU 101. When the CPU 101 decides that the instruction entered by operating the control unit 105 specifies a current position display menu (S401), the CPU 101 instructs the position finding device 103 to find the current position of the mobile station 100. Then, the CPU 101 receives current position information from the position finding device 103, stores the same in the current position data storage area 107a (S402) and makes a query to see if an image of an area including the current position is stored in the map data storage area 107d (S403). If the response in step S403 is affirmative, the CPU 101 instruct the display unit 104 to display the image of the area including the current position (S404). If the response in step S403 is negative, the CPU 101 instructs the display unit 104 to display an image data acquisition request message. When the user enters an instruction by operating the control unit 105, the control unit 105 gives the contents of the instruction to the CPU 101. When the CPU 101 decides that the entered instruction is a map information acquisition instruction, the CPU 101 requests the communication device 102 to make a call. Thus, the mobile station 100 gains access to the WWW server 601 of the geographic information center 600 and sends out a map request message (S405). In this case, the map is updated when an instruction is given by the user. A call request may be given to the communication device 102 without querying the user immediately after the CPU 101 has made a decision that a map including the current position is not found in the map data storage area 107d. The map request message includes latitude and longitude information about the latitude and longitude of the current position determined by the current position finding device 103 and information about the moving means type of the mobile station 100.

Upon the reception of the map request message, the WWW server 601 gives the map request message to the map converting/distributing server 602 (S406), and then the map converting/distributing serve 602 gives the map request message to the geographic information analyzing server 603 (S407). The geographic information analyzing server 603 extracts road data for the moving means type of the user according to the moving means type information included in the received map request message. The term “extract” signifies to read specific information from a predetermined database and to select a specific piece of data from a plurality of pieces of data. Subsequently, the geographic information analyzing server 603 takes out vector map data of an area corresponding to the latitude and longitude information included in the map request message, and a background image data 604e (S408) and sends the same to the map converting/distributing server 602 (S409). The map converting/distributing server 602 superposes the vector map data and the background image to convert the vector map data into raster map data (S410) and gives the raster map data to the WWW server 601 (S411). The WWW server 601 sends the raster map data to the mobile station 100 (S412).

The CPU 101 of the mobile station 100 receives the map data through the communication device 102, stores the received map data in the map data storage area 107d (S413) and makes the display unit 104 display a new map image (S404). Subsequently, the CPU 101 superposes an icon representing the mobile station 100 on the map image displayed by the display unit 104 (S414). Thereafter, the CPU 101 receives current position information periodically from the position finding device 103, reads a map image including the current position from the map data storage area 107d and makes the display unit 104 display the map image. The current position information does not need to be given to the CPU 101 perfectly periodically but may be given at time determined according to the condition of the mobile station 100.

If any map data representing the current position is not stored in the map data storage area 107d or any map data representing an area surrounding the current position is not stored in the map data storage area 107d, the mobile station 100 gains access to the WWW server 601 of the geographic information center 600 and sends out a map request message again and repeats the foregoing steps.

Thus, the current position of the mobile station 100 is displayed by the display unit 104. A map request message including a desired area name and a landmark name may be sent to the WWW server 601 instead of the map request message including the latitude and longitude information to display a map including optional points. When a map request message including a landmark name is sent to the WWW server 601, the geographic information analyzing server 603 makes reference to the landmark data 604h, finds latitude and longitude information on the basis of the landmark name, and the foregoing displaying procedure is executed.

Navigation Procedure

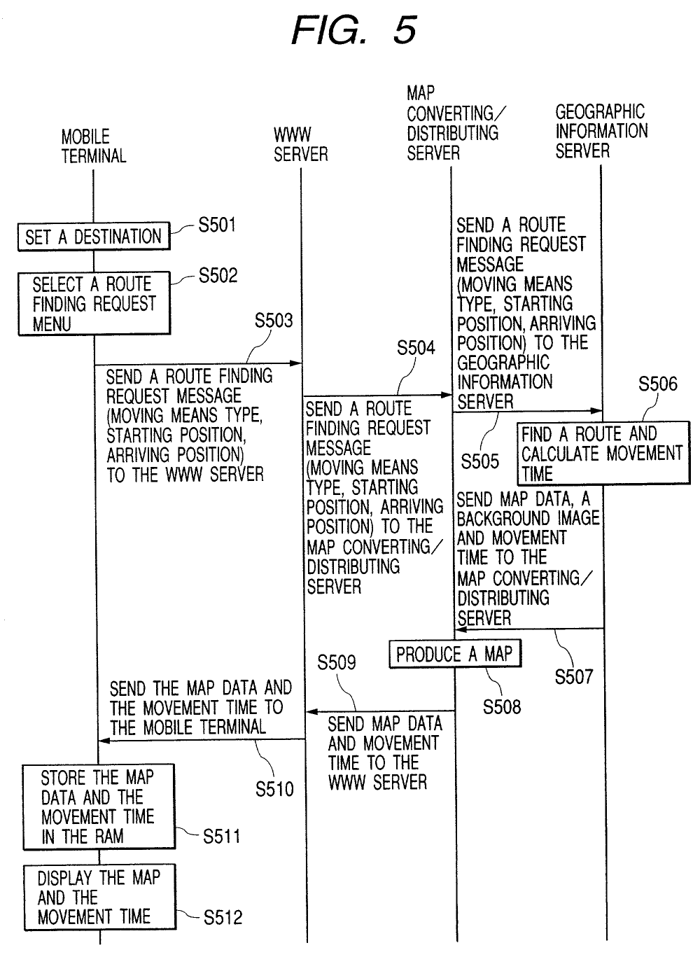

A navigation procedure for navigating automobiles, bicycles, wheelchairs or walkers will be described with reference to FIGS. 5, 12 and 13. It is supposed that current position data and moving means type data are stored in the current position data storage area 107a and the moving means type data storage area 107b of the RAM 107, respectively, by the foregoing method.

FIG. 13 is a map of an area surrounding the current position of the user. The map shown in FIG. 13 has a plurality of nodes indicated by points P1301 to P1316. Since a road between the points P1303 and P1304 is a one-way road, a link is extended only in a direction from the point P1303 to the point P1304 in the road data for automobile 604a. Since a road passing points P1308, P1309 and P1315 is a cycling road, any link is not extended for this road in the road data for automobile 604a.

Since a road between points P1305 and P1307 is a bumpy road unsuitable for wheelchairs to travel, any link is not extended between the points P1305 and P1307 in the road data for wheelchair 604c.

Bus stop information is written to points P1302, P1307 and P1313 in the bus stop position data 604g. The bus stop position data 604g has link information indicating directions from the point P1313 toward the point P1312, from the point P1312 toward the point P1307, from the point P1307 toward the point P1304 and from the point P1304 toward the point P1302 to indicate the traveling direction of a bus. Suppose that the user is now at the point P1317 and the point P1303 is a destination and it is desired to find a route from the point P1317 to the point P1303.

The user operates the control unit 105 to let the CPU 101 start a navigation program stored in the navigation program storage area 106c. The user scrolls a map image displayed by the display unit 104 of the mobile station 100 by using cursor movement keys or the like of the control unit 105 to display an area including the destination of the map image. Then, the user moves the cursor to the point P1303 to set a destination (S501). Position data on the destination is stored in the destination data storage area 107c of the RAM 107. The name of the destination may be entered by operating the control unit 105 to set the destination.

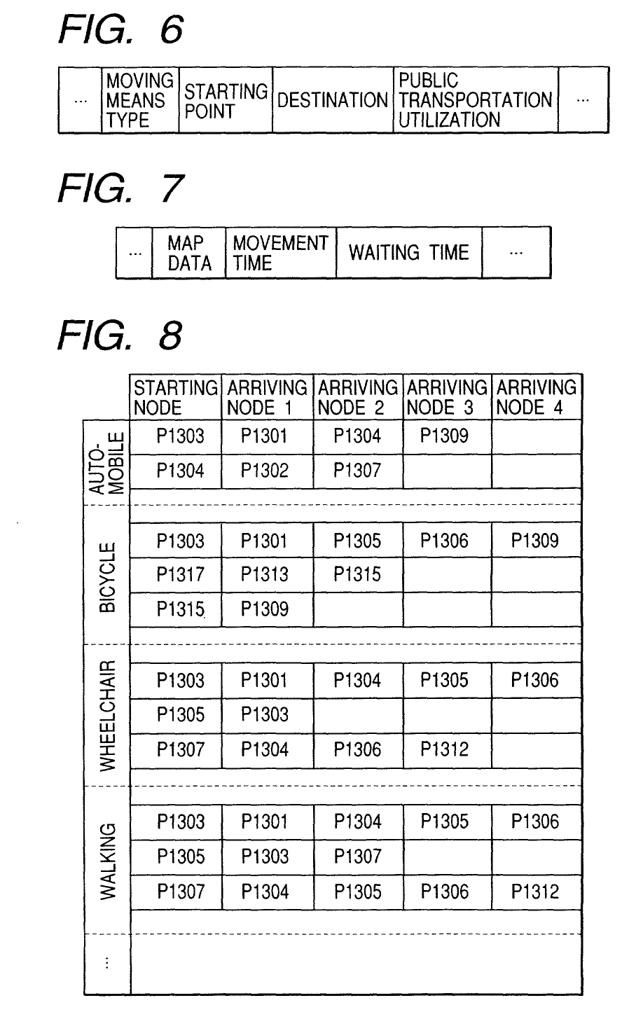

Subsequently, the user selects a route finding request menu by operating the control unit 105 (S502). The control unit 105 sends the contents of the instruction to the CPU 101. When the CPU 101 decides that the instruction indicates a route finding request, reads current position data, moving means type data and destination data from the current position data storage area 107a, the moving means type data storage area 107b and the destination data storage area 107c and produces a route finding request message as shown in FIG. 6 by way of example. The current position data indicates a starting point. When the moving means type data read from the moving means type data storage area 107b indicates walking or wheelchairs, the CPU 101 makes the display unit 104 display a selection dialog box to ask the user if the user uses public transportation. The user enters a choice by operating the control unit 105. Public transportation utilization mode data provided by the user is stored in the public transportation utilization mode data storage area 107e of the RAM 107. If the user desires to use public transportation, the-CPU 101 adds the public transportation utilization mode data to the route finding request message.

Then, the CPU 101 starts the communication program stored in the communication program storage area 106b and requests the communication device 102 to make a call. The communication program includes a procedure for gaining access to the geographic information center 600 and setting a communication circuit. The communication device 102 sets a communication circuit according to the communication program.

After the completion of the connection of the mobile station 100 and the WWW server 601 of the geographic information center 600 by the communication device 102, the CPU 101 sends the route finding request message through the communication device 102 to the WWW server 601 (S503). The WWW server 601 receives the route finding request message through an IF 610 and transfers the same through an IF 620 to the map converting/distributing server 602 (S504). The map converting/distributing server 602 sends the route finding request message to the geographic information analyzing server 603 (S505).

The geographic information analyzing server 603 receives the route finding request message through an IF 630, and then a CPU 631 decomposes the route finding request message and stores the current position data, the moving means type data, the destination data and the public transportation utilization mode data in an STR 632, i.e., a storage device. Procedures respectively for different moving means types will be separately described.

Route Finding Procedure for Automobile

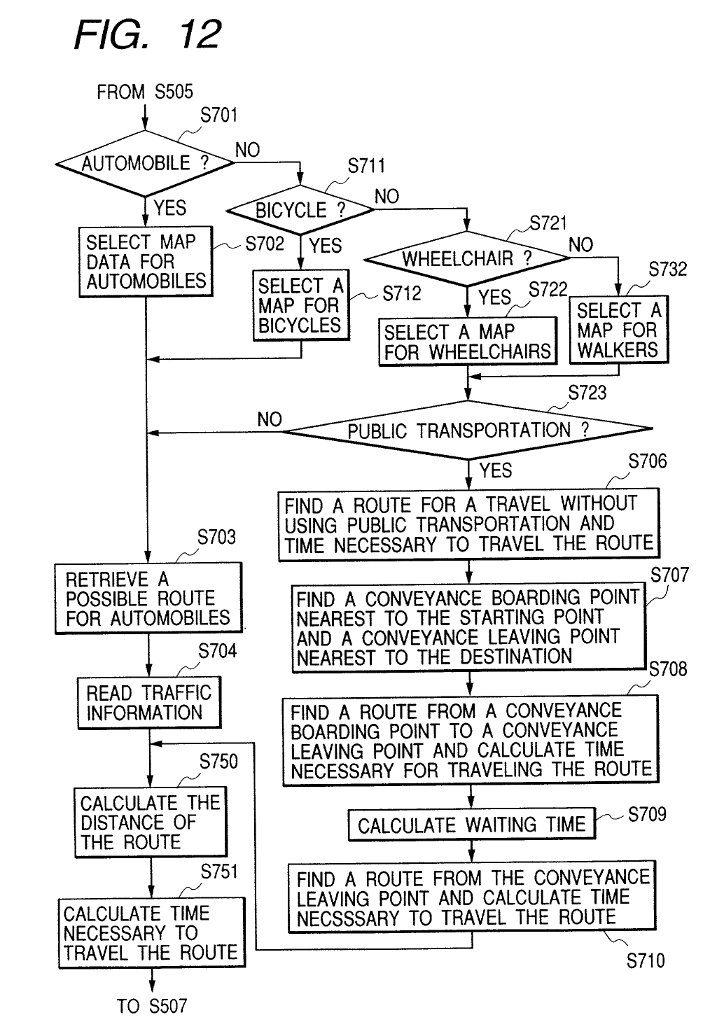

FIG. 12 shows a program to be executed in step S506. The CPU 631 of the geographic information analyzing server 603 reads the moving means type data from the STR 632. If it is decided in step S701 that the user's moving means type corresponds to automobiles, the CPU 631 selects road data for automobile 604a necessary for automobile route finding. Subsequently, the CPU 631 reads current position data and destination data from the STR 632 (S702). The CPU 631 retrieves a possible route to be proposed to the user from the road data for automobile 604a (S703). Subsequently, the CPU 631 reads traffic information relating with the possible route from the traffic database 606 (S704). The CPU 631 multiplies ordinary moving times for the sections of the possible route by coefficients associated with pieces of information about accidents, traffic congestion and construction work read from the traffic database 606 to calculate a moving time necessary for traveling through the possible route (S751). A plurality of possible routes may be retrieved and the possible route that requires the shortest moving time may be proposed as an optimum route to the user or a single route may be selected by making reference to traffic information in the stage of route retrieval so as to avoid traffic congestion.

As mentioned in Japanese Patent Laid-open No. Hei 10-307042, if a place in the possible route changes to a condition unsuitable for safe passage due to the change of the weather for the worse, information about such a place may be linked with the road information to find a route avoiding such a dangerous place.

FIG. 14 shows the result of calculation made by the geographic information analyzing server 603. A route RIO shown in FIG. 14 is determined, taking into consideration road information for automobiles and one-way roads. More concretely, since the road data on the road between the points P1303 and P1304 stored in the road data for automobile 604a indicates a one-way road, the road between the points P1303 and P1304 is excluded from possible roads. Thus, a route passing the points P1117, P1313, P1312, P1307, P1304, P1302, P1301 and P1303 is selected as a route that can be traveled in the shortest moving time.

Route Finding Procedure for Bicycle

The CPU 631 of the geographic information analyzing server 603 reads the moving means type data from the STR 632. If it is decided that the user's moving means type does not correspond to automobiles (S701) and that the user's moving means type corresponds to bicycles (S711), the CPU 631 selects road data for bicycle 604b necessary for bicycle route finding. Thereafter, the CPU 631 executes the same steps as those executed by the CPU 631 to find an optimum route for automobiles. However, since the traveling of bicycles is not affected significantly by traffic congestion, reference is not made to traffic information and step S704 is skipped. FIG. 15 shows the result of calculation made by the geographic information analyzing server 603. A route R11 shown in FIG. 15 includes a cycling road.

Route Finding Procedure for Wheelchair

When finding a route for wheelchairs, it is possible to decided whether or not public transportation is to be used by operating the control unit 105. This embodiment selects the utilization of public transportation. In this case, a route finding request message includes moving type information (wheelchairs, public transportation utilization) about the moving means type of the mobile station 100, the latitude and longitude of the current position of the mobile station 100 determined by the position finding device 103, and the latitude and longitude of a destination.

The CPU 631 of the geographic information analyzing server 603 reads the moving means type data from the STR 632. If it is decided that the user's moving means type does not correspond to automobiles (S701), that the user's moving means type does not correspond to bicycles (S711) and that the user's moving means type corresponds to wheelchairs (S721), the CPU 631 selects road data for wheelchair 604c necessary for wheelchair route finding. The CPU 631 reads the public transportation utilization mode data from the STR 32. The procedure goes to step S706 if it is decided in step S723 that public transportation is to be utilized or goes to step S703 if it is decided in step S723 that public transportation is not to be utilized. If public transportation is to be used, the CPU 631 reads latitude and longitude information about a starting point and latitude and longitude information about a destination from the STR 32, finds an optimum route and calculates time necessary to travel the route (S706). When finding a route for wheelchairs, attribute information about the respective distances of lines represented by road data for wheelchair 604c is weighted by attribute information about gradient information. Then, the CPU 631 refers to the station position data 604f or the bus stop position data 604g to find a conveyance boarding point nearest to the starting point represented by the latitude and longitude information and a conveyance leaving point nearest to the destination represented by the latitude and longitude information (S707). In this embodiment, bus is selected as a public conveyance, a point P1313 is the conveyance boarding point and a point P1307 is a conveyance leaving point. Then, the CPU 631 finds a route from the conveyance boarding point where the user takes a public conveyance and a conveyance leaving point where the user leaves the public conveyance and calculates time necessary for traveling the route (S708). In this embodiment, the bus stop position data 604g is used for finding a route from the conveyance boarding point P1313 to the conveyance leaving point P1307 and calculating time necessary for traveling the route. Then, the CPU 631 finds a route from the starting point P1317 to the conveyance boarding point P1313 and calculates time necessary to travel the route by using the road data for wheelchair 604c, and compares the calculated time after the current time with the bus timetable data included in the timetable database 605 to calculate waiting time for which the user must wait for the public conveyance to arrive (S709). Then, the CPU 631 finds a route from the conveyance leaving point P1307 to the destination P1303 and calculates time necessary to travel the route (S710). Then, the CPU 631 sends map data on an area including results of calculation, a background image for the area, the calculated movement time when public transportation is used, movement time when public transportation is not used and waiting time for waiting the public conveyance to arrive to the map converting/distributing server 602 (S507) FIG. 16 shows a route found through calculation carried out by the geographic information analyzing server 603. A route R12 shown in FIG. 16 is a wheelchair route determined by taking into consideration public transportation utilization and the condition of roads.

Route Finding Procedure for Walker

When finding a route for a walker, it is possible to decided whether or not public transportation is to be used by operating the control unit 105. This embodiment selects the utilization of public transportation. In this case, a route finding request message includes moving type information (walking, public transportation utilization) about the moving means type of the mobile station 100, the latitude and longitude of the current position of the mobile station 100 determined by the position finding device 103, and the latitude and longitude of a destination.

The CPU 631 reads the moving means type data from the STR 632. If it is decided that the user's moving means type does not correspond to automobiles (S701), that the user's moving means type does not correspond to bicycles (S711), that the user's moving means type does not correspond to wheelchairs (S721) and that the user's moving means type corresponds to walking, the CPU 631 selects road data for walking 604d necessary for walking route finding (S732). The CPU 631 reads the public transportation utilization mode data from the STR 32. The procedure goes to step S706 if it is decided in step S723 that public transportation is to be utilized or goes to step S703 if it is decided in step S723 that public transportation is not to be utilized. If public transportation is to be used, the CPU 631 reads latitude and longitude information about a starting point and latitude and longitude information about a destination from the STR 32, finds an optimum route and calculates time necessary to travel the route (S706).

The navigation system related with the present invention is unable to calculate correct movement time necessary for a walker or a wheelchair to travel a selected route only on the basis of distance between the current position and the destination when the route between the current position and the destination includes slopes. Therefore, attribute information about the respective distances of lines represented by road data for walking 604d is weighted by attribute information about gradient information when finding a route for a walker. When calculating time necessary for other moving means types to travel a selected route, distances are weighted by the speed coefficients for the moving means types. Thus, this embodiment takes the condition of roads and gradient into consideration when finding a route, so that a practically short route can be selected and actual time necessary for the walker to travel the route can be calculated.

Then, the CPU 631 refers to the station position data 604f or the bus stop position data 604g to find a conveyance boarding point nearest to the starting point represented by the latitude and longitude information and a conveyance leaving point nearest to the destination represented by the latitude and longitude information (S707). In this embodiment, a bus is selected as public conveyance, a point P1313 is the conveyance boarding point and a point P1307 is a conveyance leaving point. Then, the CPU 631 finds a route from the conveyance boarding point where the user takes a public conveyance and a conveyance leaving point where the user leaves the public conveyance and calculates time necessary for traveling the route (S708). In this embodiment, the bus stop position data 604g is used for finding a route from the conveyance boarding point P1313 to the conveyance leaving point P1307 and calculating time necessary for traveling the route. Then, the CPU 631 finds a route from the starting point P1317 to the conveyance boarding point P1313 and calculates time necessary to travel the route by using the road data for walking 604d, and compares the calculated time after the current time with the bus timetable data included in the timetable database 605 to calculate waiting time for which the user must wait for the public conveyance to arrive (S709). Then, the CPU 631 finds a route from the conveyance leaving point P1307 to the destination P1303 and calculates time necessary to travel the route (S710). Then, the CPU 631 sends map data on an area including results of calculation, a background image for the area, the calculated movement time when public transportation is used, movement time when public transportation is not used and waiting time for waiting the public conveyance to arrive to the map converting/distributing server 602 (S507). FIG. 17 shows a route found through calculation carried out by the geographic information analyzing server 603. A route R13 shown in FIG. 17 is an optimum walking route determined by taking into consideration public transportation utilization.

When public transportation is used, part of the system in this embodiment may be replaced with a system disclosed in Japanese Patent Laid-open No. Hei 9-115086. This known system executes route finding operations only for sections which are traveled without using public transportation, such as sections to be traveled on foot or by car, and omits unnecessary route finding operations, so that a route can be quickly found. On the other hand, total distance and total movement time cannot be known because only routes from the starting point to a conveyance boarding point and from a conveyance leaving point and a destination are found and a route between a conveyance boarding point and a conveyance leaving point is not found, and timetables of public transportation are not taken into consideration. Therefore the user is unable to determine starting time that eliminates waiting time for which the user needs to wait for a train to arrive, which is inconvenient to the user. The foregoing system may be preferable for the user who desires finding only routes from a starting point to a conveyance boarding point and from a conveyance leaving point to a destination because a route can be quickly found when.

Transfer and Output of Results of Route Finding Operation

A method of feeding the results of route finding operation to the user will be described hereinafter. Output of the results to the user signifies appealing to user's senses, such as displaying specific information, printing out specific information or giving audio information. Output by a device or the like signifies not only appealing to user's sense but also sending data that does not appeal directly to human senses but contributes indirectly to appealing to human senses to other devices or the like.

The CPU 631 of the geographic information analyzing server 603 sends map data of an area including the calculated results of route finding operation, a background image for the area and the calculated movement time through the IF 630 to the map converting/distributing server 602 (S507). The map converting/distributing server 602 stores the map data of an area including the calculated results of route finding operation, the background image for the area and the calculated movement time received through the IF 630 in an STR 622, i.e., a storage device. Then, a CPU 621 included in the map converting/distributing server 602 reads vector map data and a background image from the STR 622 and superposes the same to convert the vector map data into raster map data (S508), and gives the raster map data together with the calculated movement time data through the IF 620 to the WWW server 601 (S609). The WWW server 601 receives the raster map data and the calculated movement time data through the IF 610, produces packets for the mobile station 100, and sends out the packet through the IF 610 (S510). The mobile station 100 receives the raster map data through the communication device 102 and stores the same in the map data storage area 107d of the RAM 107 (S511). The CPU 101 reads the raster map data and the movement time from the map data storage area 107d and displays the same by the display unit 104 (S512). When the public transportation utilization mode is selected, waiting time for which the user must wait for a public conveyance to arrive also is displayed.

The results of route finding operation may be provided in speech instead of displaying the same. When providing the results of route finding operation in speech, the CPU 101 retrieves speech guidance associated with the results of route finding operation received from the WWW server 601 from a speech guidance data storage area 107f of the RAM 107 and controls an audio output device 109 so that the audio output device 109 describes the route between the starting point and the destination in speech. Similarly, the CPU 101 controls the audio output device 109 to provide the distance of the route, time necessary to travel the route and the like in speech guidance. The results of route finding operation may be converted into and provided in speed information instead of using previously registered speech guidance.

Map Information Update

When a conventional CD-ROM is used as a storage medium, up-to-the-second map data cannot be obtained unless the user changes the storage medium. The present invention updates road information and area information, which change frequently, whenever the occasion demands to save the user the trouble of changing the map data and to reduce the possibility of inappropriate navigation based on old maps; that is, the mobile station 100 updates the contents of the databases by using road information that changes every moment.

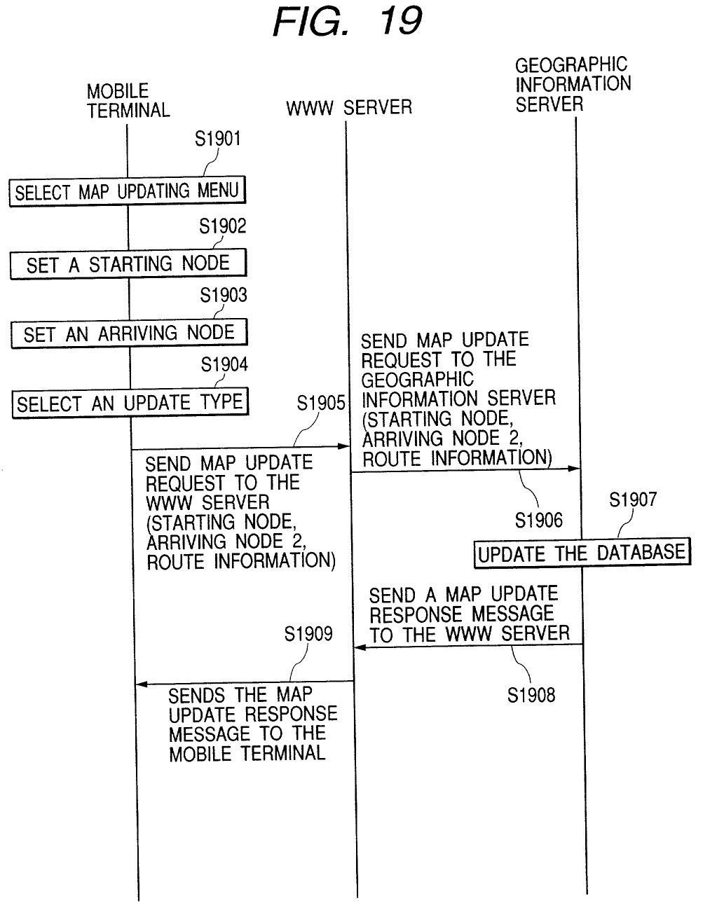

An information updating procedure for updating the geographic database 604 will be described with reference to FIG. 19. The display unit 104 displays a menu selection dialog box including a map updating menu. The user operates the control unit 105 to enter an instruction, and the control unit 105 sends the contents of the instruction to the CPU 101. When it is decided that the instruction specifies a map updating menu (S1901), the CPU 101 instructs the display unit 104 to display a starting node selection dialog box.

When the user operates the control unit 105 to specify an optional point as a starting node, the control unit 105 sends a signal to that effect to the CPU 101 (S1902). Then the CPU 101 instructs the display unit 104 to display an arriving node selection dialog box. When the user operates the control unit 105 to specify an optional point as an arriving node, the control unit 105 sends a signal to that effect to the CPU 101 (S1903).

Then, the CPU 101 instructs the display unit 104 to display a route information input dialog box. When the user operates the control unit 105 to enter route information, the control unit 105 sends the contents of the route information to the CPU 101 (S1904). The route information is attribute information about links between the starting and the arriving node and indicates at least addition/deletion of links between the two points, the moving means type, the distance between the two points and gradients of links. At least the addition/deletion information for adding or deleting the links between the two points must be entered. After the route information has been set, the CPU 101 request the communication device 102 to make a call. Thus, the CPU 101 gains access to the WWW server 601 of the geographic information center 600 and sends a map update request message to the WWW server 601 (S1905).

Upon the reception of the map update request message, the WWW server 601 transfers the map update request message to the geographic information analyzing server 603 (S1906). The geographic information analyzing server 603 selects a route database associated with a moving means type indicated by moving means type information included in the received map update request message.

If the map update request message does not include any moving means type information, the road data 604a to 604d are selected. Subsequently, the geographic information analyzing server 603 registers points corresponding to the starting and arriving node included in a map image request message in the road database and sets a link extending from the starting node to the arriving node when the route information included in the map update request message specifies link addition.

On the other hand, when the route information represents link deletion, a link from the starting node to the arriving node is removed from the road database (S1907). Subsequently, the geographic information analyzing server 603 sends a map update response message to the WWW server 601 (S1908). The WWW server 601 sends the map update response message to the mobile station 100 (S1909).

Only either the starting node or the arriving node may be specified, both the starting node and the arriving node may be set for the same point, and landmark information, such as the names of tourist attractions and buildings, positions of bus stops, positions of stations and timetable information may be set as the route information in addition to the map update request message.

Although a constitution for disposing map data on the network has been described, the map data of the present invention may be stored in a suitable storage medium and the mobile station may be provided with a reader capable of reading data from the storage medium. Navigation services respectively corresponding to the moving means types may be supplied to the users by carrying out processes to be carried out by the foregoing servers by the hardware of the mobile station.

Programs necessary for carrying out the present invention may be supplied in storage mediums or may be downloaded and installed in the server or the mobile station. The geographic data may be stored in a storage medium of the foregoing construction and the storage medium storing the geographic data may be supplied.

What is claimed is:

1. A geographic information output system comprising:
a moving means type identifying device for identifying a moving means type of a moving means to be used by a user who desires the supply of geographic information;
a position determining device for determining a geographic position of the user;
a geographic information extracting device for extracting geographic information associated with the moving means type identified by the moving means type identifying device about the position of the user determined by the position determining device from a geographic database; and
an output device for providing the extracted geographic information.

2. The geographic information output system according to claim 1 further comprising:
a destination specifying device for specifying a destination of the user; and
a route finding device for searching the geographic database for a route from the position of the user or a starting position specified by the user to the destination, the route being suitable for the moving means type identified by the moving means type identifying device by using the destination and the position of the user or the starting position specified by the user as keys for retrieval;
wherein the output device provides the route found in and retrieved from the geographic database by the route finding device.

3. The geographic information output system according to claim 2 further comprising:
a speed coefficient storage device for storing speed coefficients respectively for moving means types; and
a calculating device that reads a speed coefficient associated with a moving means type identified by the moving means type identifying device from the speed coefficient storage device, and calculates standard movement time necessary for traveling the route found by the route finding device by the moving means type identified by the moving means type identifying device by operating distance information about a distance of the route found by the route finding device and the speed coefficient read from the speed coefficient storage device;
wherein the output device provides the standard movement time calculated by the calculating device.

4. The geographic information output system according to claim 3, wherein the geographic database includes map data, the map data includes road condition data on road conditions including gradients of sections of roads or surface conditions of roads, the calculating device calculates standard movement times necessary for traveling sections of the route by using the speed coefficients for the same sections and adds up the standard movement times to provide a total standard movement time necessary for traveling the route.

5. The geographic information output system according to claim 2 further comprising a calculating device that extracts standard movement times necessary for traveling sections of the route found by the route finding device by the moving means type identified by the moving means type identifying device from map data and adds up the standard movement times to provide a total standard movement time necessary for traveling the route;
wherein the map data is included in the geographic database and includes standard movement times necessary for users of different moving means types to travel sections of routes, and
the output device provides the total movement time calculated by the calculating device.

6. The geographic information output system according to claim 2 further comprising a map storage device that stores map data on barrier-free routes;
wherein the route finding device extracts a barrier-free route from the map storage device when the moving means type of the user corresponds to wheelchairs; and
the output device displays the extracted barrier-free route.

7. A geographic information providing method comprising the steps of:
identifying a moving means of a moving means type to be used by a user who desires the supply of geographic information;
obtaining geographic data on a current geographic position of the user;
extracting geographic information for the moving means about an area surrounding the current geographic position of the user from a geographic database; and
providing the extracted geographic information.

8. The geographic information providing method according to claim 7 further comprising the steps of:
accepting information on a destination specified by the user;
finding a route from the current geographic position of the user to the destination of the user for the moving means that may be used by the user; and
sending the found route to the user.

9. A geographic information server comprising:
a receiving device that receives a moving means type of a moving means to be used by a user who desires the supply of geographic information, and a current position of the user or a specified position specified by the user through a network;
geometric information storage device previously storing geographic information needed by the user;
a retrieving device that retrieves geometric information about an area surrounding the current position of the user or a position specified by the user from the geometric information stored in the geometric information storage device by using a moving means type of the user, and the current position of the user or the position specified by the user as keys for retrieval received by the receiving device; and
a transmission device for sending the geographic information about the area around the current position of the user or the position specified by the user to the user.

10. The geographic information server according to claim 9 further comprising a route finding device for retrieving geographic data on a route for the moving means type from the current position of the user or the position specified by the user to a destination received by the receiving device from the geographic information stored in the geographic information storage device;
wherein the transmission device sends the geographic data on the route retrieved by the route finding device to the user.

11. The geographic information server according to claim 10, wherein the geographic information includes plurality of pieces of map information respectively associated with the moving means types, each piece of map information includes road information on roads that can be traveled by a moving means of the corresponding moving means type; and
the route finding device selects the map information associated with the moving means type received by the receiving device and retrieves a route from the current position of the user or the position specified by the user to the destination from the selected map information.

12. The geographic information server according to claim 10, wherein the geometric information storage device stores road availability indicating data indicating whether or not roads are suitable for moving means of the moving means types to travel, and
the route finding device finds a route by using a position where the user starts moving and the destination as keys for retrieval, and the road availability indicating data.

13. The geographic information server according to claim 9 further comprising a map updating device that analyzes road updating information provided by the user and received by the receiving device and updates the geographic information stored in the geographic information storage device;
wherein the route finding device uses the updated geographic information for finding a route and provides the user a route.

14. The geographic information server according to claim 13, wherein the road updating information includes the moving means type of the user, position information and time information about time when the position information is obtained, the map updating device stores the road updating information, determines a path of movement of the user on the basis of position information and time information included in the stored plurality of pieces of road updating information, and adds the path of the movement of the user as new road information to the geometric information when the path of movement of the user does not coincide with the road information included in the geometric information.

15. A mobile station comprising:
a moving means type identifying device that identifies a moving means type of a moving means to be used by a user;
a position obtaining device that obtains a current position of the user or a specified position specified by the user;
a transmission device that sends a map request signal including the moving means type, and the current position of the user or the specified position specified by the user and requesting a map of an area surrounding the current position of the user or the specified position to a geographic information server;
a receiving device that receives the map of the area surrounding the current position of the user or the specified position provided by the geographic information server in response to the map request; and
an output device that outputs the map of the area surrounding the current position of the user or the specified position.

16. The mobile station according to claim 15 further comprising a destination specifying device for specifying a destination of the user;
wherein the transmission device sends a route finding request including the moving means type, the destination, and the current position of the user or the specified position toward the geographic information server,
the receiving device receives route data obtained by a route finding operation carried out by the geographic information server in response to the route finding request, and
the output device displays the route data.

17. The mobile station according to claim 15 further comprising: a first specifying device for specifying a position of a road for which the map information is to be updated, and a second specifying device for specifying additional information about the road; wherein the transmission device sends a map update request including the position of the road and the additional information to the geographic information server.

18. A mobile station comprising:
an input device for entering a moving means type of a moving means to be used by a user;
a first storage area for storing the moving means type entered by the input device;
a starting point setting device for setting a starting point for navigation;
a second storage area for storing the starting point set by the starting point setting device;
an arriving point setting device for setting an arriving point for navigation;
a third storage area for storing the arriving point set by the arriving point setting device;
a route finding request producing device that reds the moving means type from the first storage area, reads the starting point from the second storage area, reads the arriving point from the third storage area, and produces a route finding request including the moving means type, the starting point and the arriving point read from the first, the second and the third storage area, respectively;
a transmitting device that transmits the route finding request produced by the route finding request producing device by radio;
a receiving device that receives route data obtained by a route finding operation carried out in response to the route finding request; and
an output device that outputs the route data received by the receiving device.

19. The mobile station according to claim 18, wherein the input device is a keyboard, a selector switch included in the mobile station or a cradle holding the mobile station,
the first, the second and the third storage area are secured in a storage device included in the mobile station,
the starting point setting device is a calculating device that calculates the position of the mobile station by using radio waves transmitted by the GPS or a base station,
the arriving point setting device and the route finding request producing device are included in a control unit connected to the input device and the storage device, and
the output device is a display unit or an audio output device included in the mobile station.

20. A mobile station holding apparatus holding a mobile station, comprising:
a holding device holding the mobile station and having a shape partly corresponding to a case containing the mobile station; and
an output device directly or indirectly connected to an external signal receiving device included in the mobile station to give a moving means type of the mobile station to the external signal receiving device.

21. A storage medium storing a data structure including data on roads, wherein the data structure is capable of:
dividing roads into a plurality of sections and representing each of the sections by two end points at opposite ends of the section;
linking two end points of a first section serving for one-way traffic among the plurality of sections by a link extended in a direction in which a user is allowed to move; and
expressing a second section serving for two-way traffic among the plurality of sections by links extending in opposite directions from opposite ends of the second section, respectively.

22. The storage medium storing the data structure according to claim 21, wherein the first section among the plurality of sections is expressed by a record having a starting point as a first point, and an arriving point as a second point, and
the second section serving for two-way traffic among the plurality of sections is expressed by a record having a starting point as a third point and an arriving point as a fourth point, and a record having a starting point as the fourth point and an arriving point as the third point.

23. The storage medium storing a data structure according to claim 22, wherein the records include gradients of the sections, and distances of the sections or times necessary for traveling the sections.
